(19) United States
(12) Patent Application Publication
(10) Pub. No.: US 2019/0137758 A1
(43) Pub. Date: May 9, 2019

(54) PSEUDO LIGHT-FIELD DISPLAY APPARATUS

(71) Applicants: THE REGENTS OF THE UNIVERSITY OF CALIFORNIA, Oakland, CA (US); DURHAM UNIVERSITY, Durham (GB); INRIA, Le Chesnay Cedex (FR)

(72) Inventors: Martin S. Banks, Berkeley, CA (US); Steven A. Cholewiak, Berkeley, CA (US); Pratul Srinivasan, Berkeley, CA (US); Yi-Ren Ng, Berkeley, CA (US); Gordon D. Love, Richmond (GB); Geroge Drettakis, Nice (FR); Georgios-Alexan Koulieris, Heraklion (GR)

(73) Assignees: THE REGENTS OF THE UNIVERSITY OF CALIFORNIA, Oakland, CA (US); DURHAM UNIVERSITY, Durham (GB); INRIA, Le Chesnay Cedex (FR)

(21) Appl. No.: 16/179,356

(22) Filed: Nov. 2, 2018

Related U.S. Application Data
(63) Continuation of application No. PCT/US2017/031117, filed on May 4, 2017.
(60) Provisional application No. 62/331,835, filed on May 4, 2016.

(51) Int. Cl. G02B 27/00; H04N 13/383; H04N 13/332; H04N 13/398; G02B 27/22; G02B 7/09; G02B 7/36

(52) U.S. Cl. CPC G02B 27/0075; H04N 13/383; H04N 13/332; H04N 13/398; H04N 13/144; G02B 27/0093; G02B 7/09; G02B 7/36; G02B 27/2235

(57) ABSTRACT

A pseudo light-field display uses a stereoscopic display viewed by a user, with a variable lens disposed between each eye and the display, and a half-silvered mirror disposed between each lens and the display. A focus measurement device operates through at least one half-silvered mirror with one of the variable lenses to detect focus of an eye, providing a focus output, and controlling both variable lenses. A gaze direction measurement device operates through both half-silvered mirrors to detect the gaze direction of each eye, and provides an output of the vergence or individual gaze directions of the eyes. The focus, vergence, and gaze directions are used to establish a visual focal plane, whereby objects on the display that are being gazed upon in the visual focal plane are in focus, with other objects appropriately blurred, thereby approximating a light-field display.

### CROSS-REFERENCE TO RELATED APPLICATIONS

This application claims priority to, and is a 35 U.S.C. § 111(a) continuation of, PCT international application NO. PCT/US2017/031117 filed on May 4, 2017, incorporated herein by reference in its entirety, which claims priority to, and the benefit of, U.S. provisional patent application Ser. No. 62/331,835 filed on May 4, 2016, incorporated herein by reference in its entirety. Priority is claimed to each of the foregoing applications.

The above-referenced PCT international application was published as PCT International Publication No. WO 2017/192882 on Nov. 9, 2017 and republished on Jul. 26, 2018, which publications are incorporated herein by reference in their entireties.

### STATEMENT REGARDING FEDERALLY SPONSORED RESEARCH OR DEVELOPMENT

This invention was made with Government support under 1354029, awarded by the National Science Foundation, and under EY020976, awarded by the National Institutes of Health. The Government has certain rights in the invention.

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to focus cues, more particularly to ocular focus and gaze interaction with a display, and still more particularly to ocular focus and gaze interaction with a stereoscopic display, whereby a pseudo light-field display field apparatus is achieved.

### 2. Background Discussion

Creating correct focus cues (blur and accommodation) has become a critical issue in the development of the next generation of 3D displays, particularly head-mounted displays. Without correct focus cues, present day 3D displays create undue visual discomfort and reduce visual performance. Contemporary attempts to solve the focus cues problem are very limited in their practical use.

Volumetric displays place light sources (volumetric pixels, or voxels) in a 3D volume by using rotating display screens or stacks of switchable diffusers. They are limited in practical application because the viewable scene is restricted to the size of the display volume. A very large number of addressable voxels is required. These displays present additive light, creating a scene of glowing, transparent voxels. This makes it impossible to reproduce occlusions and specular reflections correctly, and both are very important to creating acceptable imagery.

Multi-plane displays are a variation of volumetric displays where the viewpoint is fixed. Such displays can, in principle, provide correct focus cues with conventional display hardware. Their most serious limitation is that they require very accurate alignment between the display and the viewer's eyes. Thus, the positioning between the display and viewer's eyes must be precise and stable, which limits practical utility. Furthermore, a sufficient number of planes is required to create acceptable image quality for a workspace of reasonable volume and with each additional plane, light is lost, making the display rather dim and increasing the likelihood of visible flicker.

Light-field displays produce a four-dimensional light field, allowing glasses-free viewing. Early approaches involved lenticular arrays or parallax barriers to direct exiting light along different paths. Later approaches used compressive techniques based on multi-layer architectures. Using this approach one can, in principle, present correct focus cues, but to do so requires an extremely high angular resolution.

Recent approaches to light-field displays use a combination of a light-attenuating layer and a high-resolution backlight to steer light in the appropriate directions. Resolution requirements and computational workload are presently much too demanding to make practical light-field displays that support focus cues. Furthermore, image quality in present implementations of such technologies is significantly limited by diffraction.

### BRIEF SUMMARY

A pseudo light-field display uses a stereoscopic display viewed by a user, with a variable lens (one having an adjustable focal length) disposed between each eye and the display, and a half-silvered mirror disposed between each lens and the display. A focus measurement device operates through at least one half-silvered mirror with one of the variable lenses to detect focus of the corresponding eye, providing a focus output, and controlling both variable lenses.

Alternatively, a gaze direction measurement device may operate through both half-silvered mirrors to detect the gaze direction of each eye, and provides an output of the vergence or individual gaze directions of the eyes. The focus, vergence, and gaze directions output from the gaze measurement device are used to establish a visual focal plane, whereby objects on the display that are being gazed upon in the visual focal plane are in focus, with other objects appropriately blurred, thereby approximating a light-field display.

By way of example, and not of limitation, in one or more embodiments the presented technology allows the creation of correct focus cues with a conventional display, a dynamic lens in front of each eye, and a method to measure the current focus of the eye or to estimate the current focus from the measurement of the gaze direction of each eye. All components (except a miniature focus measuring device) are currently commercially available, so the approach is practical and solves the most difficult issues that occur (speed, resolution) that currently plague light-field displays.

The presented technology allows the creation of a display that supports focus cues with mostly commercially available and relatively inexpensive equipment. Occlusions and reflections can be handled easily. The positions of the viewer's eyes relative to the equipment should be known, but they do not need to be known with great precision. There is no light loss relative to a conventional display. The required resolution is no greater than with a conventional stereoscopic display and the computational workload is only minimally greater. Thus, the presented technology allows a practical display that supports focus cues (and therefore reduces visual discomfort and improves visual performance relative to a conventional 3D display) with bright, non-flickering, and high-resolution imagery.

The presented technology could significantly reduce the major problems that exist with current 3D display technologies that do not support focus cues. The technology may provide a less expensive and more practical solution compared to current volumetric, multi-plane, and light-field displays.

The presented technology could be integrated into head-mounted displays such as virtual reality (VR) and augmented reality (AR). The technology could be integrated into desktop displays as well, but would require eyewear in that case.

The presented technology recreates the relationship between retinal images, the focusing response of the eye, and the 3D scene that occurs in the real world. Light-field displays aim to recreate this relationship by making a digital approximation of the light field associated with the real world.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

The technology described herein will be more fully understood by reference to the following drawings which are for illustrative purposes only:

FIG. 1 is a top schematic view of an embodiment of a focus tracking display system.

FIG. 2 is a top schematic view of an embodiment of an eye tracking display system.

FIG. 3A is an abstracted schematic view where two objects in the real world at different distances, a sphere and a cube, are viewed through a lens by imaging onto an image plane.

FIG. 3B is the same geometry as found in FIG. 3A, however, here the lens has been adjusted to a different optical power, whereby the cube is now correctly focused on the image plane, while the sphere is blurred.

FIG. 4A is an abstracted schematic view where two objects are displayed on a light-field display and subsequently viewed.

FIG. 4B is the same geometry as found in FIG. 4A, however, the adjustable lens has been adjusted to a different optical power, whereby the hollow cube is now correctly focused on the image plane.

FIG. 5A is an abstracted schematic view where two objects are displayed using a pseudo light-field display and subsequently viewed.

FIG. 5B is an abstracted schematic view where two objects as found in FIG. 5A are displayed with a different focus, however, where the lens has been adjusted to a different optical power to focus on the cube.

FIG. 6 is a schematic view of a thin lens with the various geometry used to explain the thin lens formula.

### DETAILED DESCRIPTION

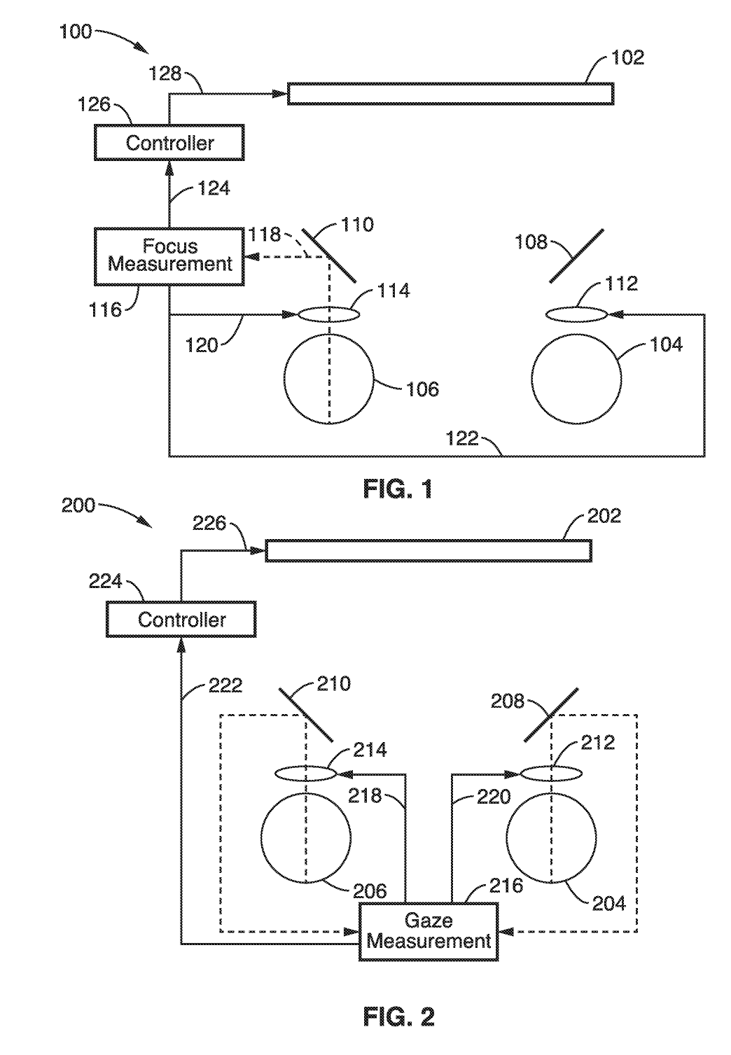

Refer now to FIG. 1, which is a top schematic view 100 of an embodiment of a focus tracking display system according to the presented technology. Here, a display screen 102 is shown with an image displayed. A user's right eye 104 and left eye 106 are depicted as mere simple circles.

Disposed between display screen 102 and both the right eye 104 and left eye 106 are respective right 108 and left 110 half-silvered mirrors.

Adjustable right 112 and left 114 lenses allow for the adjustment of optical power between: 1) the right eye 104 and left eye 106, and 2) the respective right 108 and left 110 half-silvered mirrors.

In this FIG. 1, the silvering of the left 110 half-silvered mirror additionally allows for the focus measurement 116 of the state of focus of the left eye 106.

After a measurement 116 of the focus of the left eye 106 is obtained, a left focus adjustment 120 may be made to the left 114 adjustable lens. An adjustable lens means a lens that may be driven electrically to different optical focal lengths.

Since focus is highly correlated between both the right 104 and left 106 eyes, an additional right focus adjustment 122 signal may be sent to the right 112 adjustable lens. This focal correlation between the eyes is known as “yoking”, whereby accommodation in humans operates so that a change in accommodation in one eye is accompanied by the same change in the other eye. In turn, accommodation is the process whereby the eye changes optical power to maintain a clear image or focus on an object as the object's distance varies from the eye.

By employing appropriate feedback, the focus measurement 116 may be output as a display adjustment 124 to a controller 126, which then modifies a displayed image 128 onto the display screen 102, in conjunction with the focus of the adjustable right 112 and left 114 lenses, whereby focus of both right 104 and left 106 eyes on display screen 102 is achieved. In the process of achieving this focus, the measurement 116 of the focus state may be determined, and suitably output to the controller 126 as an output signal.

Although not shown here, the measurement 116 of focus using the left eye 106 may similarly be alternatively or simultaneously used with focus measurement of the right eye 104. Additionally, in the strict implementation of focus measurement of the left 106 eye, the right 108 half-silvered mirror would not be necessary.

Refer now to FIG. 2, which is a top schematic view of an embodiment of an eye tracking display system 200 according to the presented technology. Here, a display screen 202 is shown with an image displayed. A user's right eye 204 and left eye 206 are depicted as simple circles.

Disposed between display screen 202 and both the right eye 204 and left eye 206 are respective right 208 and left 210 half-silvered mirrors.

Adjustable right 212 and left 214 lenses allow for the adjustment of optical power, and are disposed between: 1) their corresponding right eye 204 and left eye 206, and 2) their corresponding right 208 and left 210 half-silvered mirrors.

In this eye tracking display system 200, the silvering of the left 210 half-silvered mirror additionally allows for the measurement 216 of the gaze direction of the left eye 206. Similarly, the silvering of the right 208 half-silvered mirror additionally allows for the measurement 216 of the gaze direction of the right eye 204.

After measurements 216 of the gaze of the left eye 206 and right eye 204 are obtained, a left focus adjustment 218 may be made to the left 210 adjustable lens. Similarly, an additional right focus adjustment 220 may be sent to the right 212 adjustable lens.

By employing appropriate feedback, the gaze directions of the right 204 and left 206 eye may be measured 216, and may be used to output gaze directions 222 for each eye to a controller 224, which in turn adjusts images displayed 226 on the display screen 202, in conjunction with the focus of the adjustable right 212 and left 214 lenses, thereby achieving focus in both right 204 and left 206 eyes onto the display screen 202. In the process of achieving this focus, the measurement 216 of the gaze directions and vergence may be determined, and suitably output to a computer as an output signal.

Now referring to both FIG. 1 and FIG. 2, in both cases, the user views a stereoscopic display through half-silvered mirrors. Electrically controllable adjustable lenses (i.e., lenses that can be driven electrically to different focal powers) are placed in front of the eyes so that the display screen remains in good focus for the viewer even if the viewer is in fact focused farther or nearer than the physical distance between the screen and the eyes.

Blur in the images presented on the stereoscopic display screen will be rendered using conventional graphics techniques. To these conventional graphics techniques, additional techniques could be incorporated addressing known ocular chromatic aberration effects. The focal plane for rendering of an object on the display will be determined by the current focus state of the viewer's eyes; in effect, the viewer will change the rendering by refocusing his or her eyes. There is no need for precise alignment between the viewer's eyes and the display system; they must only be roughly aligned as they are in head-mounted displays (HMDs).

This display system will produce, for all intents and purposes, light-field stimuli, otherwise known as a pseudo light-field display. But the display system is not constrained by the complex optics, diffraction, and computational demands associated with present light-field displays.

In the focus tracking system, the current focus state of one eye is measured. (Accommodation in humans is yoked, so a change in accommodation in one eye is accompanied by the same change in the other eye to a high degree of correlation.) The measured accommodation of the viewer's eye is used to control two parts of the system: (1) the power of the adjustable lenses (lens power will be adjusted such that the display screen remains in sharp focus for the viewer no matter how the eye accommodates, thus yielding a “closed-loop” system); and (2) the depth-of-field blur rendering in the displayed image.

As the viewer accommodates to different distances, the depth of field will be adjusted such that the part of the displayed scene that should be in focus at the viewer's eye will in fact be in sharp focus, and points nearer and farther in the displayed scene will be appropriately blurred. In this fashion, focus cues (blur and accommodation) will be correct.

Such a method of providing appropriate blurring is accomplished in Held, R. T., Cooper, E. A., O'Brien, J. F., and Banks, M. S. 2010. Using blur to affect perceived distance and size. ACM Trans. Graph. 29, 2, Article 19 (March 2010), 16 pages. DOI=10.1145/1731047.1731057 http://doi.acm.org/10.1145/1731047.1731057, which is incorporated herein by reference in its entirety.

Refer now back to both FIG. 1 and FIG. 2. The eye tracking system of FIG. 2 is similar to the focus tracking system of FIG. 1 except that the gaze directions of the two eyes are measured (FIG. 2) instead of the accommodation of one eye (FIG. 1). From the gaze directions, the vergence of the eyes may be computed and that signal used to estimate the accommodation of the eyes. The signal will again control the focal powers of the adjustable lenses and the depth-of-field blur rendering in the displayed image.

The rendering of the depth-of-field blur will contain defocus blur, but can also contain other optical effects, e.g., chromatic aberration, spherical aberration, astigmatism, that are associated with human eyes viewing depth-varying scenes. For example, chromatic aberration produces depth-dependent chromatic fringes in the viewing of real scenes. Such effects are not typically rendered in current displays, but can be rendered in the presented technology. Such rendering would provide greater realism by mimicking what human eyes typically experience optically.

The adjustable lenses (112 and 114 of FIG. 1, and 212 and 214 of FIG. 2) are of a type capable of changing focal power over a range of at least 4 diopters at a speed of at least 40 Hz. An existing commercial product that would satisfy such requirements would be the Optotune (Optotune Switzerland AG, Optotune Headquarters, Bernstrasse 388, CH-8953 Dietikon, Switzerland) EL-16-40-TC, which has a range much greater than 4 diopters and a refresh speed greater than 40 Hz.

These adjustable lenses (112 and 114 of FIG. 1, and 212 and 214 of FIG. 2) are preferably placed as close to the eyes as possible (to avoid large changes in magnification when the lenses change power), and are positioned laterally and vertically so that their optical axis is on the line from the center of the eye's pupil to the center of the display screen.

The mirrors in front of each eye (labeled “half-silvered mirrors” above) are interchangeably called “hot mirrors” in that they reflect infrared light while allowing visible light to pass. Such mirrors are widely commercially available. By using hot mirrors, visible light from the display passes through the mirror allowing a clear image for the user. At the same time, invisible infrared light transmitted by the device measuring focus (116 in FIG. 1) will reflect off the left hot mirror 110, enter the left eye 106, reflect from the retina, reflect again off the left hot mirror 110, and enter the device measuring focus 116. This embodiment of the apparatus is shown in FIG. 1.

The embodiment shown in FIG. 2 again uses infrared light transmitted by the eye tracker to measure the gaze direction of each eye. By using infrared light, it is assured that the viewer will not be distracted by the light source being used to measure focus or to track the eyes.

The focus measurement device (116 of FIG. 1) uses infrared light reflected from the retina to measure the eye's defocus, and preferably is configured to measure defocus over a range of at least 4 diopters with an accuracy of 0.5 diopters or better and at a refresh rate of at least 20 Hz. Various commercially available devices would satisfy such requirements. For example, a Shack-Hartmann wavefront sensor can measure defocus over the required range with accuracy much better than 0.5 diopters at rates much higher than 20 Hz. The Thorlab (Thorlabs Inc., 56 Sparta Avenue, Newton, N.J. 07860, USA) WFS150-5C wavefront sensor would satisfy such requirements.

The gaze measurement 216 eye-tracking device (of FIG. 2) also uses infrared light to track the position of each eye, and is preferably configured such that eye vergence can be measured at a refresh rate of at least 20 Hz over a range of 4 diopters with an accuracy of 0.5 diopters or better. Again there are several commercially available devices that will satisfy the requirements. The Eye Link II from SR Research (SR Research Ltd., 35 Beaufort Drive, Ottawa, Ontario, Canada, K2L 2B9) is one such example.

Custom controllers may used for the two embodiments of the presented technology. For the embodiment shown in FIG. 1, the input to the controller 126 would be the current focus state 124 of the left eye 106. One output will be a signal 120 sent to the left adjustable lens 114 lens in front of the left eye 106, and corresponding right signal 122 sent to the right adjustable lens 112 in front of the right eye 104, to adjust their power to maintain focus at the display screen 102. A focus measurement 116 second output would be a focus state signal 124 sent to the controller 126 that would update the images 128 on the display screen 102 to create the appropriate depth of field rendering for the eyes' current focus state.

For the embodiment shown in FIG. 2, the output of the gaze measurement 216 would be sent to the lenses 212, 214 in front of the eyes 204, 206 to again adjust their power as needed to achieve appropriate focus. Similarly, the measurement 216 could be output 222 to the controller 224 to update the images 226 on the display screen 202.

The display screen 202 would ideally be stereo capable. Various stereo capable implementations are possible including active polarization (as practiced with Samsung televisions), split-screen stereo (as with head-mounted displays), etc.

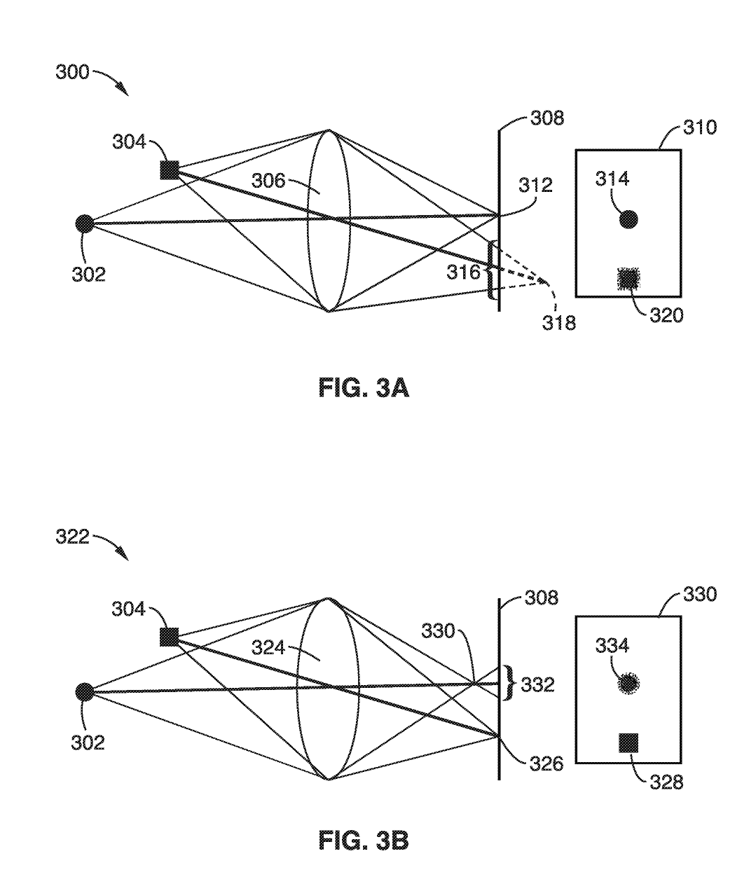

Refer now to FIG. 3A, a sphere 302 and a cube 304 are viewed through a lens 306 by imaging onto an image plane 308. Note that the sphere 302 and cube 304 are at different distances from the lens 306. The image viewed on the image plane 308 is shown on the adjacent display 310. In this example, the sphere 302 is correctly focused 312 onto the image plane 308, thereby providing a sharp sphere image 314 of the sphere 302 on the adjacent display 310.

Since cube 304 is at a different physical distance from the lens 306, its resultant focus on the image plane 308 is blurred 316, as the correct focus point 318 of the cube 304 is some distance beyond the image plane 308 as indicated by dashed lines. Therefore, on the adjacent display 310 a blurred cube 320 is observed.

Refer now to FIG. 3B, which is an abstracted schematic view 322 where the same sphere 302 and cube 304 appear in the real world, with the same geometry is shown as found in FIG. 3A. However, here the lens 324 has been adjusted to a different optical power, which results in the cube 304 is now correctly focused 326 on the image plane 308, as shown 328 in the second adjacent display 330.

Again, since the sphere 302 and cube 304 are at different distances from the lens 324, they are not both simultaneously in focus. Hence, it is seen that the sphere 302 comes to focus 330 in front of the image plane 308, resulting in a blurred sphere 332 being imaged onto image plane 308, and therefore viewed on the second adjacent display 330 as a blurred sphere 334.

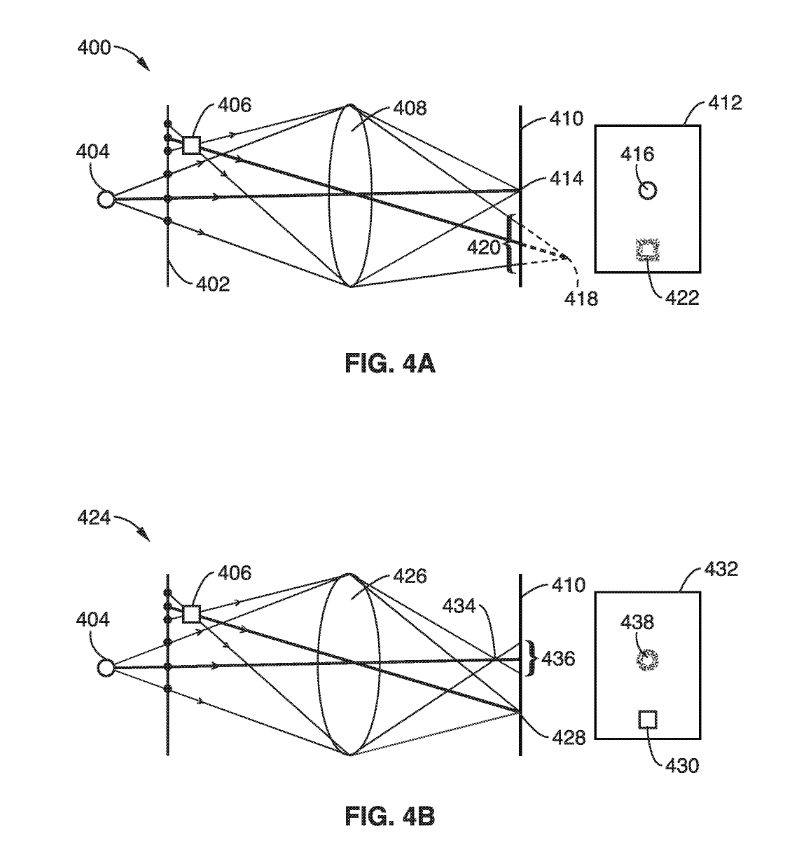

Refer now to FIG. 4A, which is an abstracted schematic view 400 where two objects are displayed on a light-field display 402 and subsequently viewed. Here, a hollow sphere 404 and a hollow cube 406 are viewed through a lens 408 by imaging onto an image plane 410. The image viewed on the image plane 410 is shown on the adjacent display 412. In this example, the hollow sphere 404 is correctly focused onto the image plane 410 at focal point 414, thereby providing a sharp hollow sphere image 416 of the hollow sphere 404 on the adjacent display 412. Since hollow cube 406 is at a different apparent distance from the lens 408, its resultant focus 418 on the image plane 410 is blurred 420 as the resultant focus point 418 of the cube 406 is some distance beyond the image plane 410, resulting in blurring 420 of the cube 406 image. The result is shown on the adjacent display 412, where the image is shown as a blurred cube 422.

Refer now to FIG. 4B, which is an abstracted schematic view 424 of the same geometry as found in FIG. 4A, however, where the lens 426 has been adjusted to a different optical power, whereby the hollow cube 406 is correctly focused 428 on the image plane 410, as shown by a sharp cube 430 in the second adjacent display 432.

Again, since the hollow sphere 404 and hollow cube 406 are at different apparent distances from the lens 426, they are not both simultaneously in focus. Hence it is seen that the hollow sphere 404 comes to focus 434 in front of the image plane 410, resulting in a blurred sphere 436 being imaged on the image plane 410. The resultant image of the blurred sphere 438 is viewed on the second adjacent display 432.

It is understood in both FIGS. 4A and 4B that the light-field display only approximates the real world light rays emanated from the objects to be displayed, thereby emulating the reality previously shown in FIG. 3A and FIG. 3B.

Light-field displays use directional pixels to create a digital approximation to the light field associated with ocular viewing of the real world. Those directional pixels are represented by small filled blue and green dots on the display. By creating the right set of directional rays, the display creates an approximation to the rays that would be created by real objects at the locations of the unfilled circles. In this way, a light-field display reproduces the relationship between 3D scene points, eye focus, and retinal images.

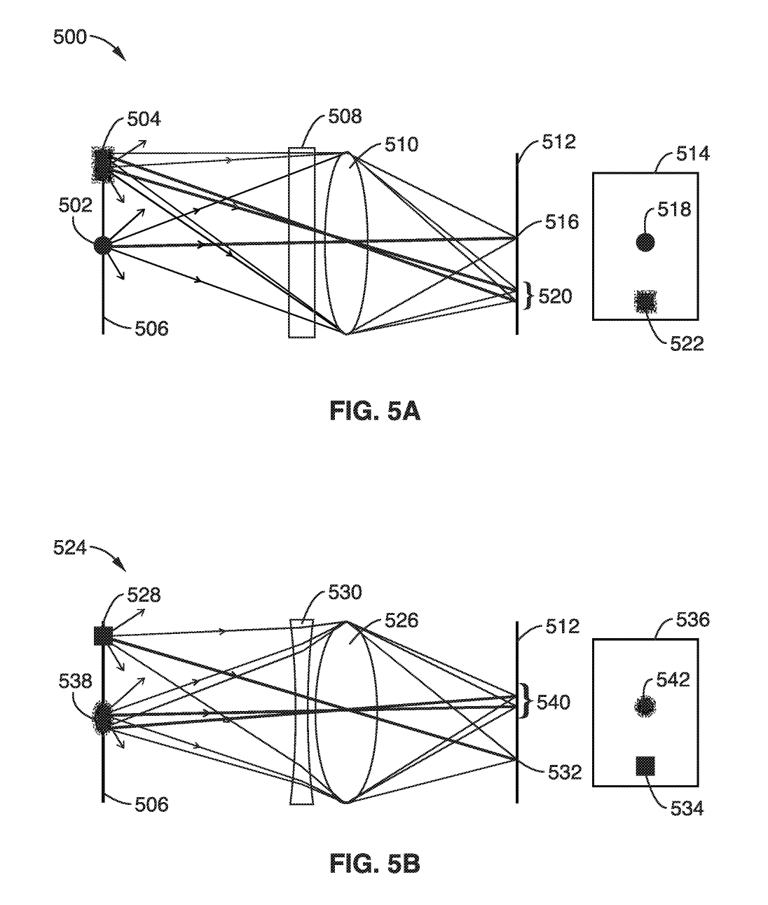

Refer now to FIG. 5A, which is an abstracted schematic view 500 where two objects are displayed using a pseudo light-field display and subsequently viewed. Here, a sphere 502 and a cube 504 are displayed on a stereoscopic display 506. The stereoscopic display 506 is viewed through an adjustable lens 508 placed before the lens 510, and thence imaged onto an image plane 512. The images viewed on the image plane 512 are shown on the adjacent display 514.

In this example, the sphere 502 is correctly focused onto the image plane 512, thereby providing a sharp sphere image 516 of the sphere 502, as seen on the adjacent display 514 as the sharp sphere image 518. Since the cube 504 is at a different apparent distance from the lens 510, it is displayed on the stereoscopic display 506 as appropriately blurred. This blurred display of the cube 504 is accordingly correctly focused 520 onto the image plane 512 as a blurred image on the adjacent display 514 as a blurred cube 522.

Here, both the sphere 502 and cube 504 are displayed on the stereoscopic display 506 at the same distance from the lens 510, so normally, if the display 506 were to display sharp objects, they would accordingly be imaged as focused objects on the image plane 512. This is exactly the case of the sphere 502 being imaged onto the image plane 516.

However, since the cube 504 was originally intended to be some distance behind the display 506, at some virtual distance beyond the depth of field, it is instead displayed as a blurred cube 504. This blurring is a result of the sphere 502 and the cube 504 being placed at different virtual visual distances from the lens 510 of the eye. The blurring mimics how the eye would see the cube 504 while being focused on the sphere 502. Since the lens 510 is correctly focused on stereoscopic display 506 a blurred cube 520 is imaged on the image plane 512. This blurred cube 520 is seen on the adjacent display 514 as a displayed blurred cube 522.

Refer now to FIG. 5B, which is an abstracted schematic view 524 where two objects as found in FIG. 5A are displayed with a different apparent focus, however, where the eye lens 526 has been adjusted to a different optical power to focus on the cube 528. Since the lens 526 has changed focus from that of FIG. 5A, the adjustable lens 530 has also been adjusted accordingly, so that stereoscopically displayed 506 sharp cube 528 is correctly focused 532 on the image plane 512, as shown 534 in the second adjacent display 536.

Since the sphere and cube are at different apparent distances from the lens 526, they are not both simultaneously in focus. As the cube is presently in focus, a sharp cube 528 is displayed. However, since the sphere is out of the depth of field, it is displayed as an appropriately blurred sphere 538. As the stereoscopic display 506 is correctly focused for the adjustable lens 530 and lens 526, a blurred sphere 540 is imaged on the image plane 512, resulting in a blurred sphere 542 being viewed on the second adjacent display 536.

Refer now to FIG. 3A and FIG. 5A. These are respectively a view of two objects directly viewed in the real world of FIG. 3A, and through a pseudo light-field display the pseudo light-field display of FIG. 5A. Here, the sphere is correctly focused in both cases.

Similarly, in FIG. 3B and FIG. 5B, two objects are directly viewed in the real world of FIG. 3B, and through a pseudo light-field display the pseudo light-field display of FIG. 5B. Here, the cube is correctly focused in both cases.

In both sets of cases above, it is seen that the pseudo light-field display correctly mimics what the eye would view in the real world, and quite similarly to the light field display of FIG. 4A and FIG. 4B.

The presented technology is termed a pseudo light-field display because it creates, for all intents and purposes, the same relationship between the scene, eye focus, and retinal images as a light-field display would.

### Optometric Interpretation

Previously, abstract terms of lens, image plane, and displays were used instead of actual structures found in human eyes. Now an analogous explanation will be given in terms of ocular structures.

Refer now to FIG. 5A and FIG. 5B, where the pseudo light-field display (“display”, which is a conventional display screen with non-directional pixels) attempts to recreate the reality of the optical view of objects in the real world of FIG. 3A and FIG. 3B, respectively.

In the pseudo light-field display of FIG. 5A and FIG. 5B, adjustable lenses in front of the eye (510 and 530 adjustable lenses) adjust for a corrected eye focus (human lens 510 and 526 are observed at different optical powers), and retinal images (512 “image plane”) to generate an image that closely correlates with ocular images viewed of the real world.

Refer now to FIG. 1. The pseudo light-field display system measures focus 116 at each moment in time where the left eye 106 is focused (or where the eyes are converged) and left adjusts 120 the power of the left adjustable lens 114 to keep the display screen 102 in good focus at the retina of the left eye 106. The appropriate blur of the simulated points is rendered by the controller 126 into the displayed image 128 depending on the dioptric power measured 116 in the left eye 106.

So as the eye's focus changes from far to near (FIG. 5A to FIG. 5B), the power of the left adjustable lens 114 is changed and the rendered blur of the points in the displayed image 128 is changed as well. In this way, the focus of the left eye 106 determines the rendering of the displayed image 128 presented on the display screen 102. Notice that the same retinal images are created as in the real world and light-field display, so this pseudo light-field display reproduces the appropriate relationship between 3D scenes, eye focus, and retinal images. It is therefore, in this respect, a light-field display. The presented technology does require that the position of the display relative to the eye is known moderately accurately, which is not a requirement for a true light-field display.

Refer now to FIG. 2. The pseudo light-field display system measures gaze 216 at each moment in time where the left eye 206 and right eye 204 are converged and left adjusts 218 the power of the left adjustable lens 214 to keep the display screen 202 in good focus at the retina of the left eye 206. In the right eye 204, a right adjust 220 causes the right adjustable lens 212 to keep the display screen 202 in good focus. Again, the appropriate blur of the simulated points is rendered into the displayed image depending on where the eye is focused according to the vergence of the eyes.

### Appropriate Blur

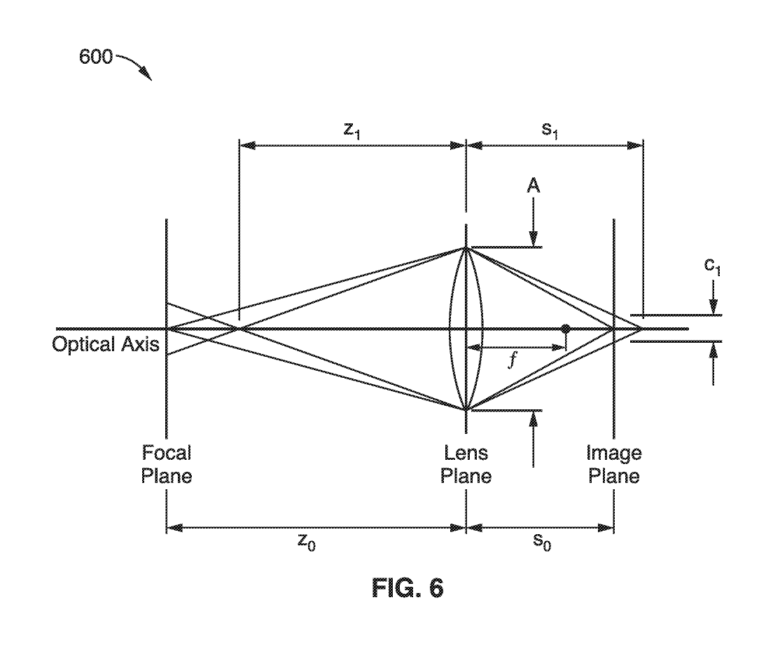

Refer now to FIG. 6, which is a schematic 600 of a simple thin lens imaging system. Here, z₀ is the focal distance of the device given the lens focal length, f, and the distance from the lens to the image plane, s₀. An object at distance z₁ creates a blur circle of diameter c_{1,} given the device aperture, A. Objects within the focal plane will be imaged in sharp focus. Objects off the focal plane will be blurred proportional to their dioptric (m⁻¹) distance from the focal plane.

When struck by parallel rays, an ideal thin lens focuses the rays to a point on the opposite side of the lens. The distance between the lens and this point is the focal length, f. Light rays emanating from a point at some other distance z₁ in front of the lens will be focused to another point on the opposite side of the lens at distance s_{1.} The relationship between these distances is given by the thin-lens equation.

With FIG. 6 now in mind, the thin lens formula may be presented:

$$\frac{1}{{s}_{1}} + \frac{1}{{z}_{1}} = \frac{1}{f} \qquad ( 1 )$$

In a typical imaging device, the lens is parallel to the image plane containing the film or charge coupled device (CCD) array. If the image plane is at distance so behind the lens, then light emanating from features at distance

$${z}_{0} = \frac{1}{( \frac{1}{f} - \frac{1}{{s}_{0}} )}$$

along the optical axis will be focused on that plane, as shown in FIG. 6. The plane at distance zo is the focal plane, so z₀ is the focal distance of the device. Objects at other distances will be out of focus, and hence will generate blurred images on the image plane. This can be expressed by the amount of blur by the diameter c of the blur circle in the image plane. For an object at distance z₁

$${c}_{1} = \vert A ( \frac{{s}_{0}}{{z}_{0}} ) ( 1 - \frac{{z}_{0}}{{z}_{1}} ) \vert ,$$

where A is the diameter of the aperture. It is convenient to substitute d for the relative distance z₁/z₀, yielding

$${c}_{1} = \vert A \frac{{s}_{0}}{{z}_{0}} ( 1 - \frac{1}{d} ) \vert \qquad ( 2 )$$

There is an appropriate relationship between the depth structure of a scene, the focal distance of the imaging device, and the observed blur in the image. From this relationship, one can determine what the depth of field would be in an image that looks natural to the human eye. Consider Eq. (2). By taking advantage of the small-angle approximation, one can express blur in angular units

$${b}_{1} = 2 {tan}^{- 1} ( \frac{{c}_{1}}{2 {s}_{0}} ) \approx \frac{{c}_{1}}{{s}_{0}} \qquad ( 3 )$$

where b₁ is in radians. Substituting into Eq. (2), one has

$${b}_{1} = \vert \frac{A}{{z}_{0}} ( 1 - \frac{1}{d} ) \vert \qquad ( 4 )$$

which means that the diameter of the blur circle in angular units depends on the depth structure of the scene and the camera aperture and not on the camera's focal length.

Suppose that one wanted to create an image with the same pattern of blur that a human viewer would experience if he or she were looking at the original scene. A photograph of the scene is taken with a conventional camera and then the viewer looks at the photograph from its center of projection. The depth structure of the photographed scene is represented by z₀ and d, with different d′s for different parts of the scene.

The blur pattern the viewer would experience when viewing the real scene may be recreated by adjusting the camera's aperture to the appropriate value. From Eq. (4), one simply needs to set the camera's aperture to the same diameter as the viewer's pupil. If a viewer looks at the resulting photograph from the center of projection, the pattern of blur on the retina would be identical to the pattern created by viewing the scene itself. Additionally, the perspective information would be correct and consistent with the pattern of blur. This creates what is called “natural depth of field.” For typical indoor and outdoor scenes, the average pupil diameter of the human eye is 4.6 mm (standard deviation is 1 mm). Thus to create natural depth of field, one should set the camera aperture to 4.6 mm, and the viewer should look at the resulting photograph with the eye at the photograph's center of projection. It is speculated that the contents of photographs with natural depth of field will have the correct apparent scale.

When using a computer graphics display the distances from the viewer's eyes are known, the blur that occurs at an image display may be calculated for each object, thereby achieving an “appropriate blur” for each object in the scene.

### Chromatic Blur

### 1. Optical Aberrations of the Eye

Although the human eye has a variety of field-dependent optical imperfections, this analysis is restricted to on-axis effects because optical imperfections are much more noticeable near the fovea and because optical quality is reasonably constant over the central 10° of the visual field. In this section, only defocus and chromatic aberration are incorporated in the rendering method. Other imperfections that could have been incorporated are ignored.

### 2. Defocus

Defocus is caused by the eye being focused at a different distance than the object. In most eyes defocus (known as sphere in optometry and ophthalmology) constitutes the great majority of the total deviation from an ideal optical system. The function of accommodation is to minimize defocus. The point-spread function (PSF) due to defocus alone is a disk whose diameter depends on the magnitude of defocus and diameter of the pupil. The disk diameter is given to close approximation by:

$$β \approx A \vert \frac{1}{{z}_{0}} - \frac{1}{{z}_{1}} \vert = A \vert Δ D \vert \qquad ( 5 )$$

where β is in angular units, A is pupil diameter, z₀ is distance to which the eye is focused, z₁ is distance to the object creating the blurred image, and ΔD is the difference in those distances in diopters. Importantly, the PSF due to defocus alone is identical whether the object is farther or nearer than the eye's current focus. Thus, rendering of defocus is the same for far and near parts of the scene.

### 3. Chromatic Aberration

The eye's refracting elements have different refractive indices for different wavelengths yielding chromatic aberration. Short wavelengths (e.g., blue) are refracted more than long wavelengths (red), so blue and red images tend to be focused, respectively, in front of and behind the retina. The wavelength-dependent difference in focal distance is longitudinal chromatic aberration (LCA). The difference in diopters is:

$$D ( λ ) = 1.731 - \frac{633.46}{λ - 214.10} \qquad ( 6 )$$

where λ is measured in nanometers. From 400-700 nm, the difference is ˜2.5D. The magnitude of LCA is the same in all adult eyes.

When the eye views a depth-varying scene, LCA produces different color effects (e.g., colored fringes) for different object distances relative to the current focus distance. For example, when the eye is focused on a white point, green is sharp in the retinal image and red and blue are not, so a purple fringe is seen around a sharp greenish center. But when the eye is focused nearer than the white point, the image has a sharp red center surrounded by a blue fringe. For far focus, the image has a blue center and red fringe. Thus, LCA can in principle indicate whether the eye is well focused and, if it is not, in which direction it should accommodate to restore sharp focus.

These color effects are generally not consciously perceived, but there is clear evidence that they affect accommodation and depth perception. LCA's role in accommodation has been studied by presenting stimuli of constant retinal size to one eye and measured accommodative responses to changes in focal distance.

Using special lenses, LCA was manipulated. Accommodation was accurate when LCA was unaltered and much less accurate when LCA was nulled or reversed. Some observers even accommodated in the wrong direction when LCA was reversed. There is also evidence that LCA affects depth perception. One study briefly presented two broadband abutting surfaces monocularly at different focal distances. Subjects perceived depth order correctly. But when the wavelength spectrum of the stimulus was made narrower (making LCA less useful), performance declined significantly. These accommodation and depth perception results are good evidence that LCA contributes to visual function even though the resulting color fringes are often not perceived.

### 4. Other Aberrations

Spherical aberration and uncorrected astigmatism have noticeable effects on the retinal image and could signal in which direction the eye must accommodate to sharpen the image. The rendering method here could in principle incorporate those effects, but was not included because these optical effects vary across individuals and therefore no universal rendering solution is feasible for them. Diffraction is universal, but has negligible effect on the retinal image except when the pupil is very small.

### Rendering Method

Knowing the viewer's eye position relative to the display as in HMDs creates a great opportunity to produce retinal images that would normally be experienced and thereby better enable accommodation and increased realism and immersion. This implementation is next described.

### 1. Calculating Retinal Images

The conventional procedures for creating blur are quite different from those presented here. In graphics, ray tracing is used to create depth dependent blur in complex scenes. For non-depth-varying scenes, the procedure is equivalent to convolving the scene with a cylinder function whose diameter is determined by the viewer's pupil size and the distance between the object and the viewer's focus distance (Eqn. 5). This approach has made great sense because the graphics designer will generally not know where the viewer(s) will be located so incorporation of physiological optical defects, such as LCA, would produce artifacts in the retinal image that do not correspond to what would be experienced in the real world.

In vision science, defocus is almost always done by convolving parts of the scene with a two-dimensional Gaussian. The aim here is to create displayed images that, when viewed by a human eye, will produce images on the retina that are the same as those produced when viewing real scenes. The model here for rendering incorporates defocus and LCA. It could include other optical effects such as higher-order aberrations and diffraction, but these are ignored here in the interest of simplicity and universality (see Other Aberrations above).

The procedure for calculating the appropriate blur kernels, including LCA, is straightforward when simulating a scene at one distance to which the eye is focused: a sharp displayed image at all wavelengths is produced, and the viewer's eye inserts the correct defocus due to LCA wavelength by wavelength. Things are more complicated for simulating objects for which the eye is out of focus. It is assumed that the viewer is focused on the display screen (i.e., green is focused at the retina). For simulated objects to appear nearer than the screen, the green and red components should create blurrier retinal images than for objects at the screen distance while the blue component should create a sharper image. To know how to render, a different blur kernel for each wavelength is needed.

Table 1 contains the README.txt file for the forward model.py and deconvolution.py that are components of the chromatic blur implementation that will be developed and described below.

### 2. Forward Model

To implement the rendering technique, one first must compute the target retinal image, which is the image desired to appear on the viewer's retina. This is done using Monte Carlo ray-tracing with the eye model, incorporating LCA for the R, G, and B primaries (red, green , and blue, respectively) of the display according to Eqn. 6. The physically based renderer Mitsuba is used for this purpose. This yields I_{{R,G,B}}(x,y) in Eqn. 7.

Table 2 contains the code for the forward model method described above, implemented in Python, and executed on Mitsuba.

### 3. Inverse Model

Once the desired image has been calculated for viewing on the viewer's retina, an image on the screen must be displayed that will achieve such a retinal image. Given that the viewer's eye is accommodated to a specific distance, the three primaries of the target retinal image at three different apparent distances must be displayed to account for LCA. This could be accomplished with complicated display setups that present R, G, and B at different focal distances. However, a more general computational solution is sought that works with conventional displays, such as laptops and HMDs.

Each color primary has a wavelength-dependent blur kernel that represents the defocus blur relative to the green primary. The forward model to calculate the desired retinal image, given a displayed image, is the convolution:

I_{{R,G,B}}(x/y)=D_{{R,G,B}}(x/y)**K_{{R,G,B}}(x/y) (7)

where I is the image that would appear on the retina as a result of displaying image D with the eye accommodated to a distance corresponding to the defocus kernel K. Note that the ** operator is taken here to be that of convolution. Next, the image to display D given a target retinal image I and the blur kernels K for each primary is estimated by inverting the forward model in Eqn. 7. This is done by solving the regularized deconvolution inverse problem:

$${min}_{D ( x , y )} {‖ {\hat{D} ( x , y )}^{**} {K}_{\{ R , G , B \}} ( x , y ) - I ( x , y ) ‖}_{2}^{2} + ψ {‖ ∇ \hat{D} ( x , y ) ‖}_{1} \\ such that 0 < \hat{D} ( x , y ) < 1. \qquad ( 8 )$$

K is given by Eqns. 5 and 6 for the R, G, and B primaries (it has zero width for G because ΔD=0 for that primary color). Eqn. 8 has a data term that is the L2 norm of the forward model residual and a regularization term with weight. The estimated displayed image is constrained to be between 0 and 1, the minimum and maximum display intensities.

The G primary (green) is well focused because the viewer is accommodated to the display, but R (red) and B (blue) are defocused. The blur kernels K are cylinder functions, but in solving Eqn. 8, they are smoothed slightly to minimize ringing artifacts. This deconvolution problem is generally ill-posed due to zeros in the Fourier transform of the kernels, so the deconvolution is regularized using a total variation image prior, which corresponds to a prior belief that the solution displayed image is sparse in the gradient domain.

By solving this regularized deconvolution problem, the correct image to display is estimated so that there is a minimal residual between the target retinal image and the displayed image after it has been processed by the viewer's eye. In this case, the residual will not be zero due to the constraint that the displayed image must be bounded by 0 and 1, and due to the regularization term, which reduces unnatural artifacts such as ringing.

The regularized deconvolution optimization problem in Eqn. 8 is convex, but it is not differentiable everywhere due to the L1 norm. There is thus no straightforward analytical expression for the solution. Therefore, the deconvolution is solved using the alternating direction method of multipliers (ADMM), a standard algorithm for solving such problems. ADMM splits the problem into linked subproblems that are solved iteratively. For many problems, including this one, each subproblem has a closed-form solution that is efficient to compute. Furthermore, both the data and regularization terms in Eqn. 8 are convex, closed, and proper, so ADMM is guaranteed to converge to a global solution.

In the implementation here, a regularization weight of =1:0 is used with an ADMM hyperparameter ρ=0:001 and the algorithm is run for 100 iterations.

Table 3 contains the code for the ADMM deconvolution method described above, implemented in Python.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that that the present disclosure encompasses multiple embodiments which include, but are not limited to, the following:

1. A focus tracking display system, comprising: (a) a stereoscopic display screen; (b) first and second adjustable lenses; (c) first and second half-silvered mirrors associated with said first and second lenses, respectively, and positioned between said first and second adjustable lenses and said stereoscopic display; (d) a measurement device configured to measure the current focus state (accommodation) of one eye of a subject viewing an image on said stereoscopic display through said lenses; and (e) a controller configured to control: (i) power of the adjustable lenses wherein power is adjusted such that the stereoscopic display screen remains in sharp focus for the subject without regard to how said one eye accommodates; and (ii) depth-of-field blur rendering in an image displayed on said stereoscopic display screen, wherein as the subject's eye accommodates to different distances, depth of field is adjusted such that a part of the displayed image that should be in focus at the subject's eye will in fact be sharp and points nearer and farther in the displayed image will be appropriately blurred.

2. An eye tracking display system, comprising: (a) a stereoscopic display screen; (b) first and second adjustable lenses; (c) first and second half-silvered mirrors associated with said first and second lenses, respectively, and positioned between said first and second adjustable lenses and said stereoscopic display; (d) a measurement device configured to measure gaze directions of both eyes of a subject viewing an image on said stereoscopic display through said lenses; and (e) a controller configured to: (i) compute vergence of the eyes from the measured gaze directions and generate a signal based on said computed vergence; and (ii) use said generated signal to estimate accommodation of the subject's eyes and control focal powers of the adjustable lenses and depth-of-field blur rendering in the displayed image such that the displayed image screen remains in sharp focus for the subject.

3. A focus tracking display method, comprising: (a) providing a stereoscopic display screen; (b) providing first and second adjustable lenses; (c) providing first and second half-silvered mirrors associated with said first and second lenses, respectively, and positioned between said first and second adjustable lenses and said stereoscopic display; (d) measure the current focus state (accommodation) of one eye of a subject viewing an image on said stereoscopic display through said lenses; (e) controlling power of the adjustable lenses wherein power is adjusted such that the stereoscopic display screen remains in sharp focus for the subject without regard to how said one eye accommodates; and (f) controlling depth-of-field blur rendering in an image displayed on said stereoscopic display screen, wherein as the subject's eye accommodates to different distances, depth of field is adjusted such that a part of the displayed image that should be in focus at the subject's eye will in fact be sharp and points nearer and farther in the displayed image will be appropriately blurred.

4. An eye tracking display method, comprising: (a) providing a stereoscopic display screen; (b) providing first and second adjustable lenses; (c) providing first and second half-silvered mirrors associated with said first and second lenses, respectively, and positioned between said first and second adjustable lenses and said stereoscopic display; (d) measuring gaze directions of both eyes of a subject viewing an image on said stereoscopic display through said lenses; and (e) computing vergence of the eyes from the measured gaze directions and generate a signal based on said computed vergence; and (f) using said generated signal to estimate accommodation of the subject's eyes and control focal powers of the adjustable lenses and depth-of-field blur rendering in the displayed image such that the displayed image screen remains in sharp focus for the subject.

5. A pseudo light-field display, comprising; a stereoscopic display that displays an image; a user viewing the stereoscopic display, the user comprising a first eye and a second eye; a first half-silvered mirror disposed between the first eye and the stereoscopic display; a first adjustable lens disposed between the first eye and the first half-silvered mirror; a second adjustable lens disposed between the second eye and the stereoscopic display; a focus measurement device disposed to beam infrared light off of the first half-silvered mirror, through the first adjustable lens, and then into the first eye; whereby a state of focus of the first eye is measured; a first focus adjustment output from the focus measurement device to the first adjustable lens; whereby the first eye is maintained in focus with the stereoscopic display regardless of first eye changes in focus by changes in the first adjustable lens; a second focus adjustment output from the focus measurement device to the second adjustable lens; whereby the second eye is maintained in focus with the stereoscopic display regardless of first eye changes in focus by changes in the first adjustable lens; a controller configured to control blur rendered in the displayed image on the stereoscopic display, wherein as the user's first eye accommodates to different focal lengths, blur is adjusted such that a part of the displayed image that should be in focus at the user's first eye will in fact be in sharp focus and points nearer and farther in the stereoscopic display image will be appropriately blurred.

6. The pseudo light-field display of any embodiment above, comprising: a second half-silvered mirror disposed between the second eye and the stereoscopic display.

7. A pseudo light-field display, comprising; a stereoscopic display that displays an image; a user viewing the stereoscopic display, the user comprising a first eye and a second eye; a first half-silvered mirror disposed between the first eye and the stereoscopic display; a second half-silvered mirror disposed between the second eye and the stereoscopic display; a first adjustable lens disposed between the first eye and the first half-silvered mirror; a second adjustable lens disposed between the second eye and the stereoscopic display; a gaze measurement device disposed to beam infrared light: (i) off of the first half-silvered mirror and into the first eye; and (ii) off of the second half-silvered mirror and into the second eye; whereby a gaze direction and focus of each of the first and second eyes is measured; a first focus adjustment output from the gaze measurement device to the first adjustable lens; whereby the first eye is maintained in focus with the stereoscopic display regardless of first eye changes in focus by changes in the first adjustable lens; a second focus adjustment output from the gaze measurement device to the second adjustable lens; whereby the second eye is maintained in focus with the stereoscopic display regardless of first eye changes in focus by changes in the first adjustable lens; a controller configured to control blur rendered in the displayed image on the stereoscopic display, wherein as the user's first eye accommodates to different focal lengths, blur is adjusted such that a part of the displayed image that should be in focus at the user's first eye will in fact be in sharp focus and points nearer and farther in the stereoscopic display image will be appropriately blurred.

8. The pseudo light-field display of any embodiment above, whereby a vergence is calculated by the gaze measurements of the first eye and second eye; and whereby the vergence is output to the controller to control a distance from the user's first eye and second eye to the image on the stereoscopic display.

9. A focus tracking display system, comprising: (a) a stereoscopic display screen; (b) a first and a second adjustable lens; (c) a first and a second half-silvered mirrors associated with said first and second lenses, respectively, and positioned between said first and second adjustable lenses and said stereoscopic display; (d) a measurement device configured to measure the current focus state (accommodation) of one eye of a subject viewing an image on said stereoscopic display through said lenses; and (e) a controller configured to control: (i) power of the adjustable lenses wherein power is adjusted such that the stereoscopic display screen remains in sharp focus for the subject without regard to how said one eye accommodates; and (ii) depth-of-field blur rendering in an image displayed on said stereoscopic display screen, wherein as the subject's eye accommodates to different distances, depth of field is adjusted such that a part of the displayed image that should be in focus at the subject's eye will in fact be sharp and points nearer and farther in the displayed image will be appropriately blurred.

10. An eye tracking display system, comprising: (a) a stereoscopic display; (b) right and left adjustable lenses; (c) right and left half-silvered mirrors associated with said right and left lenses, respectively, and positioned between said right and left adjustable lenses and said stereoscopic display; (d) a measurement device configured to measure gaze directions of both eyes of a subject viewing an image on said stereoscopic display through said lenses; and (e) a controller configured to: (i) compute vergence of the eyes from the measured gaze directions and generate a signal based on said computed vergence; and (ii) use said generated signal to estimate accommodation of the subject's eyes and control focal powers of the adjustable lenses and depth-of-field blur rendering in the displayed image such that the displayed image screen remains in sharp focus for the subject.

11. A focus tracking display method, comprising: (a) providing a stereoscopic display screen; (b) providing right and left adjustable lenses; (c) providing right and left half-silvered mirrors associated with said right and left lenses, respectively, and positioned between said right and left adjustable lenses and said stereoscopic display; (d) measuring the current focus state (accommodation) of one eye of a subject viewing an image on said stereoscopic display through said lenses; (e) controlling power of the adjustable lenses wherein power is adjusted such that the stereoscopic display screen remains in sharp focus for the subject without regard to how said one eye accommodates; and (f) controlling depth-of-field blur rendering in an image displayed on said stereoscopic display screen, wherein as the subject's eye accommodates to different distances, depth of field is adjusted such that a part of the displayed image that should be in focus at the subject's eye will in fact be sharp and points nearer and farther in the displayed image will be appropriately blurred.

12. An eye tracking display method, comprising: (a) providing a stereoscopic display; (b) providing right and left adjustable lenses; (c) providing right and left half-silvered mirrors associated with said right and left lenses, respectively, and positioned between said right and left adjustable lenses and said stereoscopic display; (d) measuring gaze directions of both eyes of a subject viewing an image on said stereoscopic display through said lenses; and (e) computing vergence of the eyes from the measured gaze directions and generate a signal based on said computed vergence; and (f) using said generated signal to estimate accommodation of the subject's eyes and control focal powers of the adjustable lenses and depth-of-field blur rendering in the displayed image such that the displayed image screen remains in sharp focus for the subject.

13. The pseudo light-field display of any embodiment above, wherein the first and second adjustable lenses have at least 4 diopters range of adjustability of focal power.

14. The pseudo light-field display of any embodiment above, wherein the first and second adjustable lenses have a refresh rate of at least 40 Hz.

15. The pseudo light-field display of any embodiment above, wherein the focus measurement device has an accuracy of greater than or equal to 0.5 diopters.

16. The pseudo light-field display of any embodiment above, wherein the focus measurement device has a refresh rate of at least 20 Hz.

17. The focus tracking display system of any embodiment above, wherein the first and second adjustable lenses have at least 4 diopters range of adjustability of focal power.

18. The focus tracking display system of any embodiment above, wherein the first and second adjustable lenses have a refresh rate of at least 40 Hz.

19. The focus tracking display system of any embodiment above, wherein the focus measurement device has an accuracy of greater than or equal to 0.5 diopters.

20. The focus tracking display system of any embodiment above, wherein the focus measurement device has a refresh rate of at least 20 Hz.

21. The eye tracking display system of any embodiment above, wherein the first and second adjustable lenses have at least 4 diopters range of adjustability of focal power.

22. The eye tracking display system of any embodiment above, wherein the first and second adjustable lenses have a refresh rate of at least 40 Hz.

23. The eye tracking display system of any embodiment above, wherein the focus measurement device has an accuracy of greater than or equal to 0.5 diopters.

24. The eye tracking display system of any embodiment above, wherein the focus measurement device has a refresh rate of at least 20 Hz.

25. The method of displaying a pseudo light-field of any embodiment above, wherein the first and second adjustable lenses have at least 4 diopters range of adjustability of focal power.

26. The method of displaying a pseudo light-field of any embodiment above, wherein the first and second adjustable lenses have a refresh rate of at least 40 Hz.

27. The method of displaying a pseudo light-field of any embodiment above, wherein the focus measurement device has an accuracy of greater than or equal to 0.5 diopters.

28. The method of displaying a pseudo light-field of any embodiment above, wherein the focus measurement device has a refresh rate of at least 20 Hz.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1
README.txt

forward_model.py takes a Mitsuba XML scene template file stored in the
″templates″ subdirectory, populates it with the appropriate parameter
values for each wavelength being simulated, calls Mitsuba to render the
images, and generates a retinal image. This file requires Python 3.6+ and
the following packages and their dependencies:

* click
* imageio
* jinja2
* numpy

deconvolution.py contains the ‘“deconv‘“ function, which is used to
perform ADMM deconvolution on a source image with a given blur
kernel, passed into the function as a NumPy matrix. It returns a decon-
volved image and the residual of the deconvolution. This file requires
Python 3.6+ and the following packages and their dependencies:

* pyfftw
* numpy

TABLE 2
forward_model.py

from builtins import *
import click
import glob
import imageio
import jinja2
import numpy as np
import os
import warnings
from subprocess import call

env =

jinja2.Environment(loader=jinja2.FileSystemLoader(os.path.join(os.path.dirname(_{—}
_file_{——}), ‘templates’)))
def rgb2gray(rgb):

return np.dot(rgb[..., :3], [0.299, 0.587, 0.114]).astype(np.float32)

def render_scene(arg_dict):

def dist_d(focus_dist, wavelength, wavelength_infocus=None,

reverse_lca=None):

# See forumula 4 in Marimont & Wandell (1994)
if reverse_lca is None:

reverse_lca = False

offset = 1.7312 − 0.63346/((wavelength_infocus / 1000.0) − 0.21410)
rerror = 1.7312 − 0.63346/((wavelength / 1000.0) − 0.21410)
rerror = rerror − offset
if reverse_lca:

rerror = −rerror

dist = focus_dist − rerror
if dist < 0.00000000001:

warnings.warn(‘Negative focus distance!’)

return max(focus_dist − rerror, 0.0000000001)

if ‘run_mitsuba’ not in arg_dict:

arg_dict[‘run_mitsuba’] = True

if ‘wavelength_infocus’ not in arg_dict:

arg_dict[‘wavelength_infocus’] = 580

if ‘remove_xml’ not in arg_dict:

arg_dict[‘remove_xml’] = True

# Provide scale if wanting to resize the object to fill the field of view
arg_dict[‘scale’] = np.tan(arg_dict[‘fov’]/2.0*np.pi/180.0)
arg_dict[‘focus_distance_d’] = dist_d(focus_dist=arg_dict[‘focus_diopters’],

wavelength=arg_dict[‘wavelength’],
wavelength_infocus=arg_dict[‘wavelength_infocus’])

arg_dict[‘focus_distance’] = 1/arg_dict[‘focus_distance_d’]
# Create folder if it doesn't already exist and populate Mitsuba scene file
if not os.path.exists(os.path.dirname(arg_dict[‘outpath’])):

os.makedirs(os.path.dirname(arg_dict[‘outpath’]))

scene = env.get_template(os.path.basename(arg_dict[‘filename’]))
scene = scene.render(arg_dict)
with open(‘{0}.xml’.format(arg_dict[‘outpath’]), “w”) as f:

f.write(scene)

# Run Mitsuba
if arg_dict[‘run_mitsuba’]:

base_args = [‘−o’, ‘{ }.out’.format(arg_dict[‘outpath’]),

{ }.xml’.format(arg_dict[‘outpath’])]
call([‘mitsuba’,] + base_args)

if arg_dict[‘remove_xml’]:

os.remove(‘{ }.xml’.format(arg_dict[‘outpath’]))

def renders_to_retinal_imgs(proj_name):

files = glob.glob(os.path.join(‘renders’, proj_name, ‘*_w520*.exr’))
# Conventional
for filename in files:

filepath, ext = os.path.splitext(filename)
path, file = os.path.split(filepath)
file = ‘_’.join(file.split(‘_’)[:−1])
folder = os.path.join(‘processed’, proj_name, ‘conventional’)
if not os.path.exists(folder):

os.makedirs(folder)

outfile = os.path.join(folder, ‘{ }.exr’.format(file))
if not os.path.isfile(outfile):

img = np.array(imageio.imread(filename, format=‘EXR-FI’))
out_img = rgb2gray(img)
imageio.imwrite(outfile, out_img, format=‘EXR-FI’)

# ChromaBlur retinal image
for filename in files:

filepath, ext = os.path.splitext(filename)
path, file = os.path.split(filepath)
file = ‘_’.join(file.split(‘_’)[:−1])
folder = os.path.join(‘processed’, proj_name, ‘retina’)
if not os.path.exists(folder):

os.makedirs(folder)

outfile = os.path.join(folder, ‘{ }.exr’.format(file))
if not os.path.isfile(outfile):

img = np.array(imageio.imread(filename, format=‘EXR-FI’))
im_g = rgb2gray(img)
img = np.array(imageio.imread(filename.replace(‘w520’, ‘w449’),

format=‘EXR-FI’))

im_b = rgb2gray(img)
img = np.array(imageio.imread(filename.replace(‘w520’, ‘w617’),

format=‘EXR-FI’))

im_r = rgb2gray(img)
dim = im_g.shape

```
  out_img = np.zeros([dim[0], dim[1], 3], dtype=np.float32)
  out_img[0:dim[0], 0:dim[1], 0] = im_r
  out_img[0:dim[0], 0:dim[1], 1] = im_g
  out_img[0:dim[0], 0:dim[1], 2] = im_b
  imageio.imwrite(outfile, out_img, format=‘EXR-FI’)
```

```
  @click.command( )
  @click.argument(‘proj_name’)
  @click.option(‘--aperture_diameter’, default=0.006, type=float, help=‘aperture
(pupil) diameter’)
  @click.option(‘--film_type’, default=‘hdr’, help=‘film types (“hdr”, “ldr”,
“numpy”)’)
  @click.option(‘--focus_diopters’, default=2.3, help=‘in-focus distance, in
diopters’)
  @click.option(‘--fov’, default=20.5, help=‘horizontal field of view in degrees’)
  @click.option(‘--img_height’, default=int(512), type=int, help=‘output image
height’)
  @click.option(‘--img_width’, default=int(512), type=int, help=‘output image
width’)
  @click.option(‘--integrator’, default=‘path’, help=‘integrator’)
  @click.option(‘--integrator_depth’, default=−1, help=‘integrator path depth’)
  @click.option(‘--sample_count’, default=16, help=‘number of samples for
sampler, should be power of 2’)
  @click.option(‘--sample_gen’, default=‘Idsampler’, help=‘sample generator’)
  @click.option(‘--wavelengths’, default=[520.0, 449.0, 617.0],
help=‘wavelengths for simulation’, multiple=True)
  def _click_main(proj_name ,aperture_diameter, film_type, focus_diopters, fov,
img_width, img_height, integrator,
```

integrator_depth, sample_count, sample_gen, wavelengths):

```
  camera_loc = np.array([0, 0, 0])
  camera_target = np.array([0, 0, −1])
  out_folder = os.path.join(‘renders’, proj_name)
  if not os.path.exists(out_folder):
```

os.makedirs(out_folder)

for wave in wavelengths:

out_file =

f‘{focus_diopters:0.3f}D_{1.0/focus_diopters:0.3f}m_w{wave:.0f}’

arg_dict = dict(aperture_diameter=aperture_diameter,

camera_loc=camera_loc,
camera_target=camera_target,
filename=f‘{proj_name}.xml’,
focus_diopters=focus_diopters,
fov=fov,
fovaxis=‘x’,
film_type=film_type,
img_width=img_width,
img_height=img_height,
integrator=integrator,
integrator_depth=integrator_depth,
mode=‘thinlens’,
outpath=os.path.join(out_folder, out_file),
sample_count=sample_count,
sample_gen=sample_gen,
wavelength=wave,
wavelength_infocus=520.0,
)

render_scene(arg_dict)

renders_to_retinal_imgs(proj_name)

if _{——}name_{——} == “_{——}main_{——}”:

_click_main( )

TABLE 3
deconvolution.py

```
  import pyfftw
  from pyfftw.interfaces.numpy_fft import fft2, ifft2
  import numpy as np
  def soft_thresh(signal, thresh):
```

return np.sign(signal)*np.maximum(np.absolute(signal)−thresh, 0)

def circshift(x, shifts):

for i in range(len(shifts)):

x = np.roll(x, shifts[i], axis=i)

return x

def psf2otf(K, outsize, dims=None):

Kshape = K.shape
# Pad to large size and circshift
padfull = [ ]
for j in range(len(Kshape)):

padfull.append((0, outsize[j] − Kshape[j]))

Kfull = np.pad(K, padfull, mode=‘constant’, constant_values=0.0)
# circshift
shifts = −np.floor_divide(np.array(Kshape), 2)
if dims is not None and dims < len(Kshape):

shifts = shifts[0:dims]

Kfull = circshift(Kfull, shifts)
# Compute OTF
otf = fft2(Kfull, dims)
return otf
def deconv(image, kernel, lam=None, rho=None, iters=None,

closed_bounds=None, **kwargs):

if lam is None:

lam = 0.001

if rho is None:

rho = 1000.0

if iters is None:

iters = 100

if closed_bounds is None:

closed_bounds = False

pyfftw.interfaces.cache.enable( )
#Deconvolve Image with Forward Model Kernel, Using TV Regularization
residual = np.zeros(iters)
#Precompute kernel/image FT and FT conjugate
dx = np.zeros((3,3), dtype=np.complex128)
dx[1,1] = 1
dx[1,2] = −1
dy = np.zeros((3,3), dtype=np.complex128)
dy[1,1] = 1
dy[2,1] = −1
DX = psf2otf(dx, image.shape)
DXC = np.conj(DX)
DY = psf2otf(dy, image.shape)
DYC = np.conj(DY)
K = psf2otf(kernel, image.shape)
KC = np.conj(K)
I = fft2(image, image.shape)
denom = (KC*K)+(rho*((DXC*DX)+(DYC*DY)))
#Create variables
x = np.zeros((image.shape[0], image.shape[1]))
z = np.zeros((image.shape[0], image.shape[1], 2), dtype=np.complex128)
u = np.zeros((image.shape[0], image.shape[1], 2), dtype=np.complex128)
v = np.zeros((image.shape[0], image.shape[1], 2), dtype=np.complex128)
V = np.zeros((image.shape[0], image.shape[1], 2), dtype=np.complex128)
#Update iterations
for i in range(iters):

#x update
v = z − u
V[:,:,0] = fft2(v[:,:,0])
V[:,:,1] = fft2(v[:,:,1])
x = ifft2(((KC*I)+(rho*((DXC*V[:,:,0])+(DYC*V[:,:,1]))))/denom)
if closed_bounds:

#Project to [0.0, 1.0]
x[x>1.0] = 1.0
x[x<0.0] = 0.0

X = fft2(x)
#z update
v[:,:,0] = ifft2(DX*X) + u[:,:,0]
v[:,:,1] = ifft2(DY*X) + u[:,:,1]
z = soft_thresh(v, lam/rho)
#u update
u[:,:,0] += ifft2(DX*X) − z[:,:,0]
u[:,:,1] += ifft2(DY*X) − z[:,:,1]
fwd = np.absolute(ifft2(X*K))
residual[i] = np.mean(np.square((fwd)−image))

return np.abs(x), residual

What is claimed is:

1. A pseudo light-field display, comprising;
a stereoscopic display that displays an image;
a user viewing the stereoscopic display, the user comprising a first eye and a second eye;
a first half-silvered mirror disposed between the first eye and the stereoscopic display;
a first adjustable lens disposed between the first eye and the first half-silvered mirror;
a second adjustable lens disposed between the second eye and the stereoscopic display;
a focus measurement device disposed to beam infrared light off of the first half-silvered mirror, through the first adjustable lens, and then into the first eye;
whereby a state of focus of the first eye is measured;
a first focus adjustment output from the focus measurement device to the first adjustable lens;
whereby the first eye is maintained in focus with the stereoscopic display regardless of first eye changes in focus by changes in the first adjustable lens;
a second focus adjustment output from the focus measurement device to the second adjustable lens;
whereby the second eye is maintained in focus with the stereoscopic display regardless of first eye changes in focus by changes in the first adjustable lens;
a controller configured to control blur rendered in the displayed image on the stereoscopic display, wherein as the user's first eye accommodates to different focal lengths, blur is adjusted such that a part of the displayed image that should be in focus at the user's first eye will in fact be in sharp focus and points nearer and farther in the stereoscopic display image will be appropriately blurred.

2. The pseudo light-field display of claim 1, comprising:
a second half-silvered mirror disposed between the second eye and the stereoscopic display.

3. The pseudo light-field display of claim 1, wherein the first and second adjustable lenses have at least 4 diopters range of adjustability of focal power.

4. The pseudo light-field display of claim 1, wherein the first and second adjustable lenses have a refresh rate of at least 40 Hz.

5. The pseudo light-field display of claim 1, wherein the focus measurement device has an accuracy of greater than or equal to 0.5 diopters.

6. The pseudo light-field display of claim 1, wherein the focus measurement device has a refresh rate of at least 20 Hz.

7. A pseudo light-field display, comprising;
a stereoscopic display that displays an image;
a user viewing the stereoscopic display, the user comprising a first eye and a second eye;
a first half-silvered mirror disposed between the first eye and the stereoscopic display;
a second half-silvered mirror disposed between the second eye and the stereoscopic display;
a first adjustable lens disposed between the first eye and the first half-silvered mirror;
a second adjustable lens disposed between the second eye and the stereoscopic display;
a gaze measurement device disposed to beam infrared light:
(i) off of the first half-silvered mirror and into the first eye; and
(ii) off of the second half-silvered mirror and into the second eye;
whereby a gaze direction and focus of each of the first and second eyes is measured;
a first focus adjustment output from the gaze measurement device to the first adjustable lens;
whereby the first eye is maintained in focus with the stereoscopic display regardless of first eye changes in focus by changes in the first adjustable lens;
a second focus adjustment output from the gaze measurement device to the second adjustable lens;
whereby the second eye is maintained in focus with the stereoscopic display regardless of first eye changes in focus by changes in the first adjustable lens;
a controller configured to control blur rendered in the displayed image on the stereoscopic display, wherein as the user's first eye accommodates to different focal lengths, blur is adjusted such that a part of the displayed image that should be in focus at the user's first eye will in fact be in sharp focus and points nearer and farther in the stereoscopic display image will be appropriately blurred.

8. The pseudo light-field display of claim 7,
whereby a vergence is calculated by the gaze measurements of the first eye and second eye; and
whereby the vergence is output to the controller to control a distance from the user's first eye and second eye to the image on the stereoscopic display.

9. The pseudo light-field display of claim 7, wherein the first and second adjustable lenses have at least 4 diopters range of adjustability of focal power.

10. The pseudo light-field display of claim 7, wherein the first and second adjustable lenses have a refresh rate of at least 40 Hz.

11. The pseudo light-field display of claim 7, wherein the gaze measurement device has an accuracy of greater than or equal to 0.5 diopters.

12. The pseudo light-field display of claim 7, wherein the gaze measurement device has a refresh rate of at least 20 Hz.

13. A focus tracking display system, comprising:
(a) a stereoscopic display screen;
(b) a first and a second adjustable lens;
(c) a first and a second half-silvered mirrors associated with said first and second lenses, respectively, and positioned between said first and second adjustable lenses and said stereoscopic display;
(d) a measurement device configured to measure the current focus state (accommodation) of one eye of a subject viewing an image on said stereoscopic display through said lenses; and
(e) a controller configured to control:
(i) power of the adjustable lenses wherein power is adjusted such that the stereoscopic display screen remains in sharp focus for the subject without regard to how said one eye accommodates; and
(ii) depth-of-field blur rendering in an image displayed on said stereoscopic display screen, wherein as the subject's eye accommodates to different distances, depth of field is adjusted such that a part of the displayed image that should be in focus at the subject's eye will in fact be sharp and points nearer and farther in the displayed image will be appropriately blurred.

14. An eye tracking display system, comprising:
(a) a stereoscopic display;
(b) right and left adjustable lenses;
(c) right and left half-silvered mirrors associated with said right and left lenses, respectively, and positioned between said right and left adjustable lenses and said stereoscopic display;
(d) a measurement device configured to measure gaze directions of both eyes of a subject viewing an image on said stereoscopic display through said lenses; and
(e) a controller configured to:
(i) compute vergence of the eyes from the measured gaze directions and generate a signal based on said computed vergence; and
(ii) use said generated signal to estimate accommodation of the subject's eyes and control focal powers of the adjustable lenses and depth-of-field blur rendering in the displayed image such that the displayed image screen remains in sharp focus for the subject.

15. A focus tracking display method, comprising:
(a) providing a stereoscopic display screen;
(b) providing right and left adjustable lenses;
(c) providing right and left half-silvered mirrors associated with said right and left lenses, respectively, and positioned between said right and left adjustable lenses and said stereoscopic display;
(d) measuring the current focus state (accommodation) of one eye of a subject viewing an image on said stereoscopic display through said lenses;
(e) controlling power of the adjustable lenses wherein power is adjusted such that the stereoscopic display screen remains in sharp focus for the subject without regard to how said one eye accommodates; and
(f) controlling depth-of-field blur rendering in an image displayed on said stereoscopic display screen, wherein as the subject's eye accommodates to different distances, depth of field is adjusted such that a part of the displayed image that should be in focus at the subject's eye will in fact be sharp and points nearer and farther in the displayed image will be appropriately blurred.

16. An eye tracking display method, comprising:
(a) providing a stereoscopic display;
(b) providing right and left adjustable lenses;
(c) providing right and left half-silvered mirrors associated with said right and left lenses, respectively, and positioned between said right and left adjustable lenses and said stereoscopic display;
(d) measuring gaze directions of both eyes of a subject viewing an image on said stereoscopic display through said lenses; and
(e) computing vergence of the eyes from the measured gaze directions and generate a signal based on said computed vergence; and
(f) using said generated signal to estimate accommodation of the subject's eyes and control focal powers of the adjustable lenses and depth-of-field blur rendering in the displayed image such that the displayed image screen remains in sharp focus for the subject.

17. A method of displaying a pseudo light-field, comprising;
providing a stereoscopic display that displays an image;
providing a user viewing the stereoscopic display, the user comprising a first eye and a second eye;
providing a first half-silvered mirror disposed between the first eye and the stereoscopic display;
providing a first adjustable lens disposed between the first eye and the first half-silvered mirror;
providing a second adjustable lens disposed between the second eye and the stereoscopic display;
measuring a state of focus of the first eye with a focus measurement device disposed to beam infrared light off of the first half-silvered mirror, through the first adjustable lens, and then into the first eye;
outputting a first focus adjustment output from the focus measurement device to the first adjustable lens;
maintaining the first eye in focus with the stereoscopic display regardless of first eye changes in focus by changes in the first adjustable lens;
outputting a second focus adjustment output from the focus measurement device to the second adjustable lens;
maintaining the second eye in focus with the stereoscopic display regardless of first eye changes in focus by changes in the first adjustable lens;
rendering the displayed image on the stereoscopic display via a controller configured to control blur, wherein as the user's first eye accommodates to different focal lengths, blur is adjusted such that a part of the displayed image that should be in focus at the user's first eye will in fact be in sharp focus and points nearer and farther in the stereoscopic display image will be appropriately blurred.

18. The method of displaying the pseudo light-field display of claim 17, wherein the first and second adjustable lenses have at least 4 diopters range of adjustability of focal power.

19. The method of displaying the pseudo light-field display of claim 17, wherein the first and second adjustable lenses have a refresh rate of at least 40 Hz.
